(19) United States
(12) Patent Application Publication
(10) Pub. No.: US 2006/0162334 A1
(43) Pub. Date: Jul. 27, 2006

(54) Turbo-Hybrid Automobile

(75) Inventor: Kyle George Roesler, Thornton, CO (US)

Correspondence Address: KYLE G. ROESLER, 13922 ADAMS ST., THORNTON, CO, 80602, US

(73) Assignee: Mr. Kyle George Roesler, Thornton, CO (US)

(21) Appl. No.: 10/905,877

(22) Filed: Jan. 25, 2005

(51) Int. Cl. F02B 33/44

(52) U.S. Cl. 60/612

(57) ABSTRACT

Gas-electric hybrid cars improve both the gas mileage and performance of the automobile. They are most effective when the batteries are fully charged, so the electric motor can take a large role in moving the vehicle. Unfortunately, in practice, the batteries tend to remain about two-thirds charged both in the city and on the highway. This results in the electric motor often not being utilized, especially when starting the car from a halt. A sequential two-stage turbocharger will improve performance and gas mileage. The smaller, more responsive turbocharger is connected to an electric generator, sending electricity to the batteries whenever the engine is running. A wastegate on the turbocharger is utilized to keep the generator from spinning too rapidly. The second, larger turbocharger is connected to an air compressor, as in a standard turbocharger, so when more horsepower from the gasoline motor is required it will be available. Some possible results of this improvement: 1) Fewer batteries may be required, because the vehicle can be designed to use electric power all the time. The batteries can be sized for what's required to re-start the car from an auto-stop and to get the car moving from a stop. This will result is a much lighter car with better storage space and better gas mileage. 2) The vehicle can be built with a larger electric motor, so it takes a larger responsibility for moving the car. This allows a smaller gas motor for the same total horsepower, resulting in a lighter car with better gas mileage.

Use a sequential two-stage turbocharger on a gas-electric hybrid car.

What is claimed is:

1. A gas-electric car with a sequential two-stage turbocharger will get better gas mileage for two reasons: 1) It will have more horsepower per pound of engine, and 2) It will connect the smaller of the two turbochargers to a generator to help keep the batteries at as high a state of charge as possible. These two factors will also result in better performance and drivability for the vehicle.
